(19) United States
(12) Patent Application Publication
(10) Pub. No.: US 2017/0192750 A1
(43) Pub. Date: Jul. 6, 2017

(54) Numeric conversion method and electronic device

(71) Applicants: Le Holdings (Beijing) Co., Ltd., Beijing (CN); Lemobile Information Technology (Beijing) Co., Ltd., Beijing (CN)

(72) Inventor: Jianjun Wei, Beijing (CN)

(21) Appl. No.: 15/244,697

(22) Filed: Aug. 23, 2016

Related U.S. Application Data
(63) Continuation of application No. PCT/CN2016/088523, filed on Jul. 5, 2016.

(30) Foreign Application Priority Data
Dec. 31, 2015 (CN) 201511029688.7

(51) Int. Cl. G06F 7/491

(52) U.S. Cl. CPC G06F 7/491

(57) ABSTRACT

The application provides a numeric conversion method, an electronic device, and a mobile phone. The numeric conversion method includes: first, acquiring the type of language used by a user; acquiring decimal counting units corresponding to the type of language used by the user; determining a position for adding one or more decimal counting units corresponding to the type of language used by the user into a numeric value, the numeric value comprising a numeric value input by the user and a numeric value obtained by operation; and at each position, adding a decimal counting unit corresponding to the position to obtain a converted numeric value. Therefore, the type of language used by a user can be recognized, and numeric conversion can be adaptively adjusted according to the type of language used by the user, to meet the reading requirements of different users, and facilitate users' reading, thereby avoiding the phenomenon of incorrect input or incorrect reading, and improving the user experience.

### CROSS REFERENCE TO RELATED APPLICATIONS

This application is a continuation of International Application No. PCT/CN2016/088523, filed on Jul. 5, 2016, which is based upon and claims priority to Chinese Patent Application No. 201511029688.7, filed on Dec. 31, 2015, titled “Numeric Conversion Method and Device, and Mobile Phone”, and the entire contents of which are incorporated herein by reference.

### TECHNICAL FIELD

The disclosure relates to the technical field of data processing, and particularly relates to a numeric conversion method and an electronic device.

### BACKGROUND

A calculator is an indispensable calculation tool in today's life, so that for calculating large numeric values, the calculator is often used in general. At present, many mobile terminals such as mobile phones are provided therein with calculator software, to facilitate users' calculation of large numeric values at any time. However, if numeric values are large and have many digit positions, it is easy to miss to input or additionally input “0”, causing incorrect operation results. In addition, because operation results of calculator are all expressed by digits as well, if the numeric values of the operation results are large and have many digit positions, users also need to carefully read, which is easy to cause incorrect reading because of negligence in addition to wasting energy.

At present, there is a calculator, which can display after adding decimal counting units in corresponding positions of the operation result, for example, this numeric value, i.e. 1223457632, will be displayed as 12 hundred million 2345 ten thousand 7632, thereby facilitating users' reading. However, if users are foreigners and don't know Chinese, it will not bring any convenience for users in reading.

To sum up, the calculator in the prior art is limited in use because it cannot recognize the language used by the user and adaptively adjust numeric display according to the language used by the user.

### SUMMARY

The disclosure provides a numeric conversion method, an electronic device and a mobile phone to overcome the defect that the calculator in the prior art is limited in use because it cannot recognize the language used by the user and adaptively adjust numeric conversion according to the language used by the user.

Thus, the disclosure provides the following technical solutions:

one objective of the embodiments of the disclosure is to provide a numeric conversion method used for a mobile terminal, including the following steps:

acquiring the type of language used by a user;

acquiring decimal counting units corresponding to the type of language used by the user;

determining a position for adding one or more decimal counting units corresponding to the type of language used by the user into a numeric value, the numeric value including a numeric value input by the user and a numeric value obtained by operation; and

adding a decimal counting unit corresponding to the position to obtain a converted numeric value, at each position.

The method of the disclosure, wherein, the step of acquiring the type of language used by a user includes:

acquiring the type of language set in a mobile terminal; and

taking the type of language set in the mobile terminal as the type of language used by the user.

The method of the disclosure, wherein the step of acquiring decimal counting units corresponding to the type of language used by the user includes:

pre-saving decimal counting units corresponding to various types of language; and

querying decimal counting units corresponding the type of language, according to the type of language used by the user.

The method of the disclosure, wherein, the step of determining the a position for adding one or more decimal counting units corresponding to the type of language used by the user into a numeric value includes:

judging whether the type of language used by the user is Chinese;

taking every four digits of the integer part of the numeric value in a right-to-left order as a position for adding a decimal counting unit corresponding to the type of language used by the user, if the type of language used by the user is Chinese; otherwise

taking every three digits of the integer part of the numeric value in a right-to-left order as a position for adding a decimal counting unit corresponding to the type of language used by a user.

Another objective of the embodiments of the disclosure is to provide a mobile phone, including a display device, further including a numeric conversion electronic device mentioned above, wherein the display device is used for displaying a numeric value obtained by the conversion of the numeric conversion electronic device.

The other objective of the embodiments of the disclosure is to provide a mobile phone, characterized in including:

a numeric conversion apparatus used for acquiring the type of language used by a user and decimal counting units corresponding to the type of language used by the user, determining a position for adding one or more decimal counting units corresponding to the type of language used by the user into a numeric value, the numeric value including a numeric value input by the user and a numeric value obtained by operation, and at each position, adding a decimal counting unit corresponding to the position to obtain a converted numeric value; and

a display electronic device used for displaying the numeric value obtained by the conversion of the numeric conversion apparatus.

The other objective of the embodiments of the disclosure is to provide an electronic apparatus used for a mobile terminal, at least one processor and a memory which is in communication with the at least one processor; wherein, instructions which can be executed by the at least one processor are stored in the memory; and the instruction are executed by the at least one processor so as to allow the at least one processor to be capable of acquiring the type of language used by a user; acquiring decimal counting units corresponding to the type of language used by the user; determining a position for adding one or more decimal counting units corresponding to the type of language used by the user into a numeric value, the numeric value including a numeric value input by the user and a numeric value obtained by operation; and adding a decimal counting unit corresponding to the position to obtain a converted numeric value, at each position.

The electronic device, wherein, the step of acquiring the type of language used by a user includes: acquiring the type of language set in a mobile terminal; and taking the type of language set in the mobile terminal as the type of language used by the user.

The electronic device, wherein, the step of acquiring decimal counting units corresponding to the type of language used by the user includes pre-saving decimal counting units corresponding to various types of language; and querying decimal counting units corresponding the type of language, according to the type of language used by the user.

The electronic device, wherein, the step of determining the a position for adding one or more decimal counting units corresponding to the type of language used by the user into a numeric value includes judging whether the type of language used by the user is Chinese; taking every four digits of the integer part of the numeric value in a right-to-left order as a position for adding a decimal counting unit corresponding to the type of language used by the user, if the type of language used by the user is Chinese; otherwise taking every three digits of the integer part of the numeric value in a right-to-left order as a position for adding a decimal counting unit corresponding to the type of language used by a user.

The other objective of the embodiment of the disclosure is to provide a non-transitory computer memory medium in which computer executable instructions are stored. The computer executable instructions are executed so as to allow the electronic device to be capable of acquiring the type of language used by a user; acquiring decimal counting units corresponding to the type of language used by the user; determining a position for adding one or more decimal counting units corresponding to the type of language used by the user into a numeric value, the numeric value including a numeric value input by the user and a numeric value obtained by operation; and adding a decimal counting unit corresponding to the position to obtain a converted numeric value, at each position.

Wherein, the step of acquiring the type of language used by a user includes: acquiring the type of language set in a mobile terminal; and taking the type of language set in the mobile terminal as the type of language used by the user.

Wherein, the step of acquiring decimal counting units corresponding to the type of language used by the user includes pre-saving decimal counting units corresponding to various types of language; and querying decimal counting units corresponding to the type of language, according to the type of language used by the user.

Wherein, the step of determining the a position for adding one or more decimal counting units corresponding to the type of language used by the user into a numeric value includes judging whether the type of language used by the user is Chinese; taking every four digits of the integer part of the numeric value in a right-to-left order as a position for adding a decimal counting unit corresponding to the type of language used by the user, if the type of language used by the user is Chinese; otherwise taking every three digits of the integer part of the numeric value in a right-to-left order as a position for adding a decimal counting unit corresponding to the type of language used by a user.

The technical solution of the disclosure has the following advantages.

The disclosure provides a numeric conversion method and an electronic device. The numeric conversion method includes: first, acquiring the type of language used by a user; acquiring decimal counting units corresponding to the type of language used by the user; determining a position for adding one or more decimal counting units corresponding to the type of language used by the user into a numeric value, the numeric value including a numeric value input by the user and a numeric value obtained by operation; and at each position, adding a decimal counting unit corresponding to the position to obtain a converted numeric value. Therefore, the type of language used by the user can be recognized, and numeric conversion can be adaptively adjusted according to the type of language used by the user, to meet the reading requirements of different users, and facilitate users' reading, thereby avoiding the phenomenon of incorrect input or incorrect reading, and improving the user experience.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a specific example of a numeric conversion method in embodiment 1 of the disclosure;

FIG. 2 is a flow diagram of a specific example for acquiring the type of language used by a user of the numeric conversion method in embodiment 1 of the disclosure;

FIG. 3 is a flow diagram of a specific example for acquiring decimal counting units corresponding to the type of language used by the user of the numeric conversion method in embodiment 1 of the disclosure;

FIG. 4 is a flow diagram of a specific example for determining a position for adding decimal counting unit(s) into a numeric value of the numeric conversion method in Embodiment 1 of the disclosure;

FIG. 5 is an effect diagram of a specific example for displaying a converted numeric value of the numeric conversion method in Embodiment 1 of the disclosure;

FIG. 6 is a structural block diagram of a specific example of a numeric conversion electronic device in Embodiment 2 of the disclosure;

FIG. 7 is a structural schematic diagram of a specific example of a mobile phone in Embodiment 4 of the disclosure;

FIG. 8 is a structural diagram of hardware of the electronic device provided by Embodiments of the disclosure.

### REFERENCE SIGNS

1—language type acquisition unit; 2—counting unit acquisition unit; 3—adding position determination unit; 4—counting unit adding unit; 5—display unit; 11—setting acquisition subunit; 12—language type determination subunit; 21—pre-saving subunit; 22—query subunit; 31—judgment subunit; 32—position determination subunit; 41—numeric conversion apparatus; 42—display device.

### DETAILED DESCRIPTION

In order to clearly describe objectives, the technical solutions and advantages of the disclosure. A clear and complete description of the technical solutions in the disclosure will be given below, in conjunction with the accompanying drawings in the embodiments of the disclosure. Apparently, the embodiments described below are a part, but not all, of the embodiments of the disclosure.

### Embodiment 1

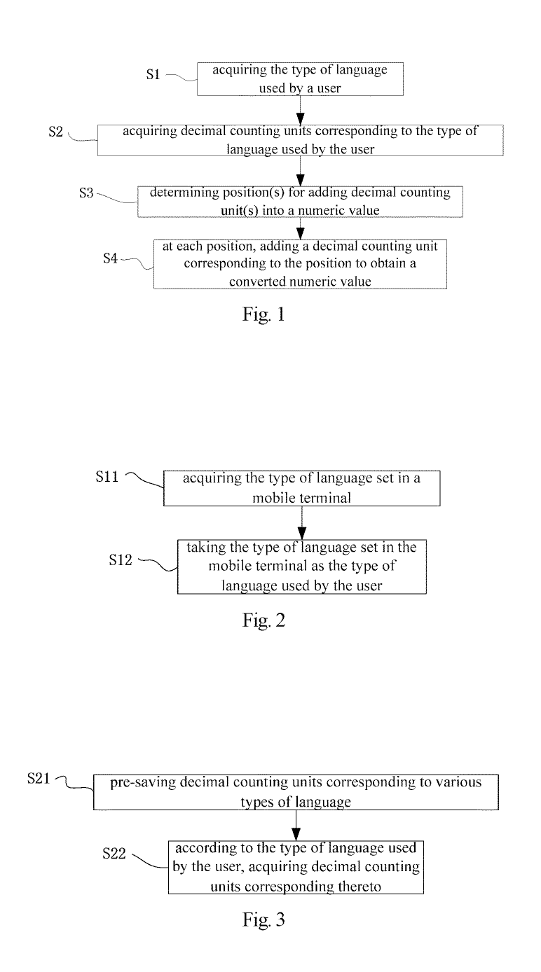

This embodiment provides a numeric conversion method used for a mobile terminal, specifically, the mobile terminal includes but is not limited to a mobile phone, a personal digital assistant (PDA), a handheld computer or a tablet personal computer and the like. The above-mentioned mobile terminal is provided therein with calculator software, to facilitate users' calculation of large numeric values. As shown in FIG. 1, the numeric conversion method in this embodiment includes the following steps:

S1. the type of language used by a user is acquired. Specifically, the type of characters which can be recognized by the user and decimal counting units which can be accustomed by the user can be judged by acquiring the type of language used by the user. Therefore, acquiring accurate type of language used by the user provides a reference basis for determining the decimal counting units corresponding to the type of language used by the user and the positions for adding decimal counting units into a numeric value at the later stage.

Preferably, as shown in FIG. 2, the step S1 includes:

S11. the type of language set in a mobile terminal is acquired. Specifically, the mobile terminal is provided therein with language setting options, so that the characters displayed by the mobile terminal can be set, and the type of language set in the terminal equipment can be acquired by reading identifiers corresponding to setting results in the language setting options of the mobile terminal.

S12. the type of language set in the mobile terminal is taken as the type of language used by the user. Specifically, if the type of language set by the user in the mobile terminal is Chinese, the characters displayed by the mobile terminal are Chinese characters, and if the type of language set by the user is English, the characters displayed by the mobile terminal are English characters, and so on. Obviously, the type of language set in the mobile terminal is the type of language which is used by the user and can be recognized by the user.

Of course, in addition to determining the type of language used by the user by acquiring the type of language set by the user in the mobile terminal, the type of language used by the user can be determined using other methods, for example, the type of language used by the user can be acquired by reading an identifier related to an input method set by the user in the mobile terminal, if it is read that the frequently-used input method set by the user is the Sogou input method, it can be known that the type of language used by the user is Chinese, and if it is read that the frequently-used input method set by the user is the English input method, it can be known that the type of language used by the user is English.

S2. decimal counting units corresponding to the type of language used by the user is acquired. Specifically, if the type of language used by the user is Chinese, namely, Chinese characters are characters which can be recognized by the user, decimal counting units corresponding to the type of language used by the user are one, ten, hundred, thousand, ten thousand, hundred thousand, million, ten million, hundred million and the like; and if the type of language used by the user is English, namely, English characters are characters which can be recognized by the user, decimal counting units corresponding to the type of language used by the user are thousand, million, billion and the like.

Preferably, as shown in FIG. 3, the step S2 includes:

S21. decimal counting units corresponding to various types of language is pre-saved.

S22. according to the type of language used by the user, acquiring decimal counting units corresponding thereto. Specifically, decimal counting units corresponding to various types of language can be saved in a read-only memory in the terminal equipment, and the decimal counting units corresponding to the type of language used by the user can be queried by accessing the read-only memory.

S3. a position for adding one or more decimal counting units corresponding to the type of language used by the user into a numeric value is determined, the numeric value including a numeric value input by the user and a numeric value obtained by operation. Specifically, decimal counting units are added into the numeric value input by the user, to facilitate users' reading, so that the user can find the error in time even if he/she incorrectly inputs, thereby effectively avoiding the phenomenon of missing to input or additionally inputting “0”; and decimal counting units are added into the numeric value obtained by operation, to facilitate users' reading, thereby effectively avoiding the phenomenon of incorrect reading or incorrect transcription.

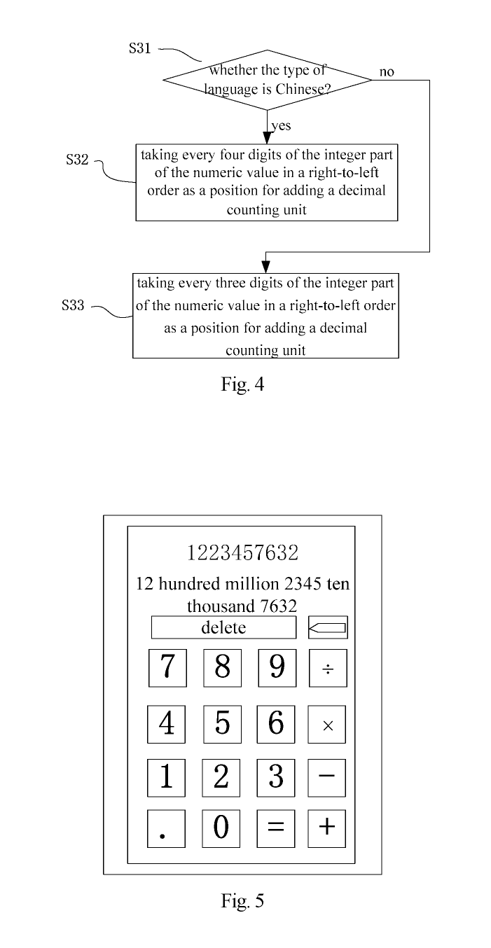

Preferably, as shown in FIG. 4, the step S3 includes:

S31. whether the type of language used by the user is Chinese is judged.

S32. every four digits of the integer part of the numeric value in a right-to-left order as a position for adding a decimal counting unit corresponding to the type of language used by the user is taken if the type of language used by the user is Chinese.

S33. every three digits of the integer part of the numeric value in a right-to-left order as a position for adding a decimal counting unit corresponding to the type of language used by the user is taken if type of language used by the user is not Chinese.

Specifically, when reading digits, the classification method of using every four digits as a digit level is used in China in general, while the classification method of using every three digits as a digit level is used internationally in general. Therefore, if the type of language used by the user is Chinese, every four digits of the integer part of the numeric value in a right-to-left order can be taken as a position for adding a decimal counting unit; and if the type of language used by the user is not Chinese, every three digits of the integer part of the numeric value in a right-to-left order can be taken as a position for adding a decimal counting unit, so that the a position for adding decimal counting unit(s) into the numeric value can be adaptively adjusted according to the requirements of different users, to facilitate users' reading, thereby improving the user experience. Of course, a decimal counting unit corresponding to the position can be added after each digit, specifically, some adjustments can be made according to the requirements of users.

S4. at each position, a decimal counting unit corresponding to the position is added to obtain a converted numeric value. The converted numeric value is convenient for users to read, thereby avoiding the phenomenon of incorrect input or incorrect reading. Specifically, taking this numeric value, i.e. 1223457632 as an example, as shown in FIG. 5, if the language used by the user is Chinese, at a position before the first four digits in a right-to-left order, since the decimal counting unit corresponding to the position is ten thousand, “ten thousand” is added at the position; and at a position before the second four digits, since the decimal counting unit corresponding to the position is hundred million, “hundred million” is added at the position, so that the converted numeric value, i.e. “12 hundred million 2345 ten thousand 7632” is obtained, and this converted numeric value, i.e. “12 hundred million 2345 ten thousand 7632” is displayed in a row below the numeric value displayed on the display electronic device such as display screen of the mobile terminal; and if the language used by the user is English, at a position before the first three digits in a right-to-left order, since the decimal counting unit corresponding to the position is thousand, “thousand” is added at the position; at a position before the second three digits, since the decimal counting unit corresponding to the position is million, “million” is added at the position; and at a position before the third three digits, since the decimal counting unit corresponding to the position is billion, “billion” is added at the position, so that the converted numeric value, i.e. “1 billion 234 million 457 thousand 632” is obtained, and this converted numeric value, i.e. “1 billion 234 million 457 thousand 632” is displayed in a row below the numeric value displayed on the display device such as display screen of the mobile terminal. Thus, numeric conversion modes can be adaptively adjusted according to different users, to facilitate users' reading, thereby avoiding the phenomenon of incorrect input or incorrect reading.

By means of the numeric conversion method in this embodiment, the type of language used by a user can be recognized, and numeric conversion can be adaptively adjusted according to the type of language used by the user, to meet the reading requirements of different users, and facilitate users' reading, thereby avoiding the phenomenon of incorrect input or incorrect reading, and improving the user experience.

### Embodiment 2

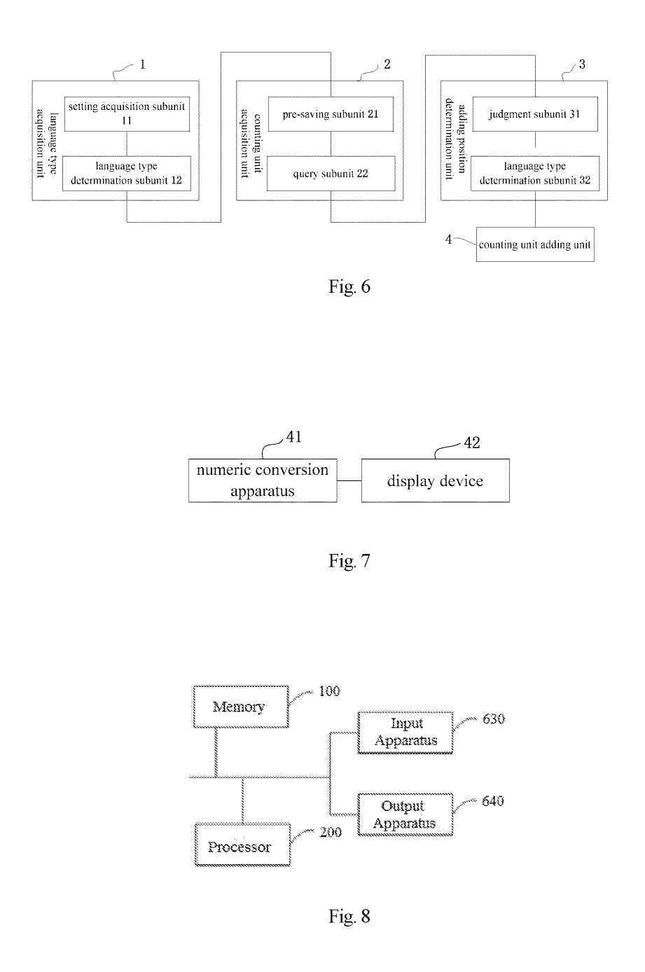

This embodiment provides a numeric conversion device used for a mobile terminal. As shown in FIG. 6, the numeric conversion device includes a language type acquisition unit 1 that acquires the type of language used by a user,

wherein preferably, the language type acquisition unit 1 includes:

a setting acquisition subunit 11 that acquires the type of language set in the mobile terminal; and

a language type determination subunit 12 that takes the type of language set in the mobile terminal as the type of language used by the user;

a counting unit acquisition unit 2 that acquires decimal counting units corresponding to the type of language used by the user,

wherein preferably, the counting unit acquisition unit 2 includes:

a pre-saving subunit 21 that pre-saves decimal counting units corresponding to various language types; and

a query subunit 22 that according to the type of language used by the user, acquires decimal counting units corresponding thereto;

an adding position determination unit 3 that determines a position for adding one or more decimal counting units corresponding to the type of language used by a user into a numeric value, the numeric value including a numeric value input by the user and a numeric value obtained by operation,

wherein preferably, the adding position determination unit 3 includes:

a judgment subunit 31 that judges whether the type of language used by the user is Chinese; and

a position determination subunit (32) that takes every four digits of the integer part of the numeric value in a right-to-left order as a position for adding a decimal counting unit corresponding to the type of language used by the user if the type of language used by the user is Chinese; and taking every three digits of the integer part of the numeric value in a right-to-left order as a position for adding a decimal counting unit corresponding to the type of language used by the user if the type of language used by the user is not Chinese; and

a counting unit adding unit 4 that at each position, adds a decimal counting unit corresponding to the position to obtain a converted numeric value.

By means of the numeric conversion device in this embodiment, the type of language used by a user can be recognized, and numeric conversion can be adaptively adjusted according to the type of language used by the user, to meet the reading requirements of different users, and facilitate users' reading, thereby avoiding the phenomenon of incorrect input or incorrect reading, and improving the user experience.

### Embodiment 3

This embodiment provides a mobile phone, including a display device, and further including the electronic device in Embodiment 2, wherein the display device is used for displaying a numeric value obtained by the conversion of the electronic device.

The mobile phone in this embodiment can recognize the type of language used by a user, acquire decimal counting units corresponding to the type of language used by the user according to the type of language used by the user, determine a position for adding one or more decimal counting units corresponding to the type of language used by the user into a numeric value accordingly, the numeric value including a numeric value input by the user and a numeric value obtained by operation, and then at each position, add a decimal counting unit corresponding to the position to obtain a converted numeric value, and display the numeric value obtained by conversion by the display device. Thus, numeric conversion can be adaptively adjusted according to the type of language used by the user, to meet the reading requirements of different users, and facilitate users' reading, thereby avoiding the phenomenon of incorrect input or incorrect reading, and improving the user experience.

### Embodiment 4

This embodiment provides a mobile phone. As shown in FIG. 7, the mobile phone includes:

a numeric conversion apparatus 41 that acquires the type of language used by a user and decimal counting units corresponding to the type of language used by the user, determining a position for adding one or more decimal counting units corresponding to the type of language used by the user into a numeric value, the numeric value including a numeric value input by the user and a numeric value obtained by operation, and then at each position, adding a decimal counting unit corresponding to the position to obtain a converted numeric value; and

a display device 42 that displays the numeric value obtained by the conversion of the numeric conversion apparatus 11.

For the mobile phone in this embodiment, the numeric conversion apparatus 41 thereof can recognize the type of language used by the user, acquire decimal counting units corresponding to the type of language used by the user according to the type of language used by the user, determine a position for adding one or more decimal counting units corresponding to the type of language used by the user into a numeric value accordingly, the numeric value including a numeric value input by the user and a numeric value obtained by operation, and then at each position, add a decimal counting unit corresponding to the position to obtain a converted numeric value; and the display device 42 thereof can display the numeric value obtained by the conversion of the numeric conversion apparatus 41. Thus, numeric conversion can be adaptively adjusted according to the type of language used by the user, to meet the reading requirements of different users, and facilitate users' reading, thereby avoiding the phenomenon of incorrect input or incorrect reading, and improving the user experience.

### Embodiment 5

A non-transitory computer-readable storage medium storing executable instructions that, when executed by an electronic device, cause the electronic device to: be capable of acquiring the type of language used by a user; acquire decimal counting units corresponding to the type of language used by the user; determine a position for adding one or more decimal counting units corresponding to the type of language used by the user into a numeric value, the numeric value including a numeric value input by the user and a numeric value obtained by operation; and add a decimal counting unit corresponding to the position to obtain a converted numeric value, at each position.

As one preferable technical solution, the step of acquiring the type of language used by a user includes: acquiring the type of language set in a mobile terminal; and taking the type of language set in the mobile terminal as the type of language used by the user.

As one preferable technical solution, the step of acquiring decimal counting units corresponding to the type of language used by the user includes pre-saving decimal counting units corresponding to various types of language; and querying decimal counting units corresponding to the type of language, according to the type of language used by the user.

As one preferable technical solution, the step of determining the a position for adding one or more decimal counting units corresponding to the type of language used by the user into a numeric value includes judging whether the type of language used by the user is Chinese; taking every four digits of the integer part of the numeric value in a right-to-left order as a position for adding a decimal counting unit corresponding to the type of language used by the user, if the type of language used by the user is Chinese; otherwise taking every three digits of the integer part of the numeric value in a right-to-left order as a position for adding a decimal counting unit corresponding to the type of language used by a user.

### Embodiment 6

FIG. 8 is a structural diagram of hardware of the electronic device provided by embodiments of the numeric conversion method and an electronic device. As shown in FIG. 8, the device includes: one or more processors 200 and a memory 100, wherein one processor 200 is shown in the FIG. 8 as an example. The device for executing the numeric conversion method further includes an input apparatus 630 and an output apparatus 640.

The processor 200, the memory 100, the input apparatus 630 and the output apparatus 640 may be connected via a bus line or other elements, wherein connection via a bus line is shown in FIG. 10 as an example.

The memory 100 is a non-transitory computer-readable memory medium that can be used to store non-transitory software programs, non-transitory computer-executable programs and modules, such as the program instructions/modules corresponding to the numeric conversion method of the embodiments of the disclosure (e.g. language type acquisition unit 1; counting unit acquisition unit 2; adding position determination unit 3; and counting unit adding unit shown in the FIG. 6). The processor 200 executes the non-transitory software programs, instructions and modules stored in the memory 100 so as to perform various function disclosure and data processing of the server, thereby implementing the numeric conversion method of the above-mentioned method embodiments

The memory 100 includes a program storage area and a data storage area, wherein, the program storage area can store an operation system and disclosure programs required for at least one function; the data storage area can store data generated by use of the numeric conversion device. Furthermore, the memory 100 may include a high-speed random access memory, and may also include a non-volatile memory, e.g. at least one magnetic disk memory unit, flash memory unit, or other non-volatile solid-state memory unit. In some embodiments, optionally, the memory 100 includes a remote memory accessed by the processor 200, and the remote memory is connected to the numeric conversion device via network connection. Examples of the aforementioned network include but not limited to internet, intranet, LAN, GSM, and their combinations.

The input apparatus 630 receives digit or character information, so as to generate signal input related to the user configuration and function control of the numeric conversion device. The output apparatus 640 includes display devices such as a display screen.

The one or more modules are stored in the memory 100 and, when executed by the one or more processors 200, perform the numeric conversion method of any one of the above-mentioned method embodiments.

The above-mentioned product can perform the method provided by the embodiments of the disclosure and have function modules as well as beneficial effects corresponding to the method. Those technical details not described in this embodiment can be known by referring to the method provided by the embodiments of the disclosure.

The electronic device of the embodiments of the disclosure can exist in many forms, including but not limited to:

(1) Mobile communication devices: The characteristic of this type of device is having a mobile communication function with a main goal of enabling voice and data communication. This type of terminal device includes: smartphones (such as iPhone), multimedia phones, feature phones, and low-end phones.

(2) Ultra-mobile personal computer devices: This type of device belongs to the category of personal computers that have computing and processing functions and usually also have mobile internet access features. This type of terminal device includes: PDA, MID, UMPC devices, such as iPad.

(3) Portable entertainment devices: This type of device is able to display and play multimedia contents. This type of terminal device includes: audio and video players (such as iPod), handheld game players, electronic books, intelligent toys, and portable GPS devices.

(4) Servers: devices providing computing service. The structure of a server includes a processor, a hard disk, an internal memory, a system bus, etc. A server has an architecture similar to that of a general purpose computer, but in order to provide highly reliable service, a server has higher requirements in aspects of processing capability, stability, reliability, security, expandability, manageability.

(5) Other electronic devices having data interaction function.

The above-mentioned device embodiments are only illustrative, wherein the units described as separate parts may be or may not be physically separated, the component shown as a unit may be or may not be a physical unit, i.e. may be located in one place, or may be distributed at multiple network units. According to actual requirements, part of or all of the modules may be selected to attain the purpose of the technical scheme of the embodiments.

By reading the above-mentioned description of embodiments, those skilled in the art can clearly understand that the various embodiments may be implemented by means of software plus a general hardware platform, or just by means of hardware. Based on such understanding, the above-mentioned technical scheme in essence, or the part thereof that has a contribution to related prior art, may be embodied in the form of a software product, and such a software product may be stored in a computer-readable memory medium such as ROM/RAM, magnetic disk or optical disk, and may include a plurality of instructions to cause a computer device (which may be a personal computer, a server, or a network device) to execute the methods described in the various embodiments or in some parts thereof.

Finally, it should be noted that: The above-mentioned embodiments are merely illustrated for describing the technical scheme of the disclosure, without restricting the technical scheme of the disclosure. Although detailed description of the disclosure is given with reference to the above-mentioned embodiments, those skilled in the art should understand that they still can modify the technical scheme recorded in the above-mentioned various embodiments, or substitute part of the technical features therein with equivalents. These modifications or substitutes would not cause the essence of the corresponding technical scheme to deviate from the concept and scope of the technical scheme of the various embodiments of the disclosure.

What is claimed is:

1. A numeric conversion method used for a mobile terminal, comprising the following steps:
acquiring the type of language used by a user;
acquiring decimal counting units corresponding to the type of language used by the user;
determining a position for adding one or more decimal counting units corresponding to the type of language used by the user into a numeric value, the numeric value comprising a numeric value input by the user and a numeric value obtained by operation; and
adding a decimal counting unit corresponding to the position to obtain a converted numeric value, at each position.

2. The method of claim 1, wherein, the step of acquiring the type of language used by a user includes:
acquiring the type of language set in a mobile terminal; and
taking the type of language set in the mobile terminal as the type of language used by the user.

3. The method of claim 1, wherein, the step of acquiring decimal counting units corresponding to the type of language used by the user includes:
pre-saving decimal counting units corresponding to various types of language; and
querying decimal counting units corresponding the type of language, according to the type of language used by the user.

4. The method of any of claim 1, wherein, the step of determining the a position for adding one or more decimal counting units corresponding to the type of language used by the user into a numeric value includes:
judging whether the type of language used by the user is Chinese;
taking every four digits of the integer part of the numeric value in a right-to-left order as a position for adding a decimal counting unit corresponding to the type of language used by the user, if the type of language used by the user is Chinese; otherwise
taking every three digits of the integer part of the numeric value in a right-to-left order as a position for adding a decimal counting unit corresponding to the type of language used by a user.

5. An electronic device used for a mobile terminal, comprising:
one or more processors;
a memory; and
one or more programs, stored in the memory, and when executed by the one or more processors performing the following steps of:
acquiring the type of language used by a user;
acquiring decimal counting units corresponding to the type of language used by the user;
determining a position for adding one or more decimal counting units corresponding to the type of language used by the user into a numeric value, the numeric value comprising a numeric value input by the user and a numeric value obtained by operation; and
adding a decimal counting unit corresponding to the position to obtain a converted numeric value, at each position.

6. The electronic device according to claim 5, wherein, the step of acquiring the type of language used by a user includes:
acquiring the type of language set in a mobile terminal; and
taking the type of language set in the mobile terminal as the type of language used by the user.

7. The electronic device according to claim 5, wherein, the step of acquiring decimal counting units corresponding to the type of language used by the user includes:
pre-saving decimal counting units corresponding to various types of language; and
querying decimal counting units corresponding the type of language, according to the type of language used by the user.

8. The electronic device according to any one of claim 5, wherein, the step of determining the a position for adding one or more decimal counting units corresponding to the type of language used by the user into a numeric value includes:
judging whether the type of language used by the user is Chinese;
taking every four digits of the integer part of the numeric value in a right-to-left order as a position for adding a decimal counting unit corresponding to the type of language used by the user, if the type of language used by the user is Chinese; otherwise
taking every three digits of the integer part of the numeric value in a right-to-left order as a position for adding a decimal counting unit corresponding to the type of language used by a user.

9. A non-transitory computer memory medium in which computer executable instructions are stored, wherein, the computer executable instructions are executed so as to allow the electronic device to be capable of:
acquiring the type of language used by a user;
acquiring decimal counting units corresponding to the type of language used by the user;
determining a position for adding one or more decimal counting units corresponding to the type of language used by the user into a numeric value, the numeric value comprising a numeric value input by the user and a numeric value obtained by operation; and
adding a decimal counting unit corresponding to the position to obtain a converted numeric value, at each position.

10. The non-transitory computer memory medium according to claim 9, wherein, the step of acquiring the type of language used by a user includes:
acquiring the type of language used by a user includes:
acquiring the type of language set in a mobile terminal; and
taking the type of language set in the mobile terminal as the type of language used by the user.

11. The non-transitory computer memory medium according to claim 9 wherein, the step of acquiring decimal counting units corresponding to the type of language used by the user includes:
pre-saving decimal counting units corresponding to various types of language; and
querying decimal counting units corresponding the type of language, according to the type of language used by the user.

12. The non-transitory computer memory medium according to claim 9, wherein, the step of determining the a position for adding one or more decimal counting units corresponding to the type of language used by the user into a numeric value includes:
judging whether the type of language used by the user is Chinese;
taking every four digits of the integer part of the numeric value in a right-to-left order as a position for adding a decimal counting unit corresponding to the type of language used by the user, if the type of language used by the user is Chinese; otherwise
taking every three digits of the integer part of the numeric value in a right-to-left order as a position for adding a decimal counting unit corresponding to the type of language used by a user.
